(19) United States
(12) Patent Application Publication
(10) Pub. No.: US 2007/0125238 A1
(43) Pub. Date: Jun. 7, 2007

(54) Brewing and drinking receptacle

(76) Inventors: Kevin Urquhart, Birtley (GB); Riad Hosein, Dublin (GB); Rani Bhamra, Surrey (GB)

Correspondence Address: MYERS BIGEL SIBLEY & SAJOVEC, PO BOX 37428, RALEIGH, NC, 27627, US

(21) Appl. No.: 10/580,593

(22) PCT Filed: Nov. 25, 2004
(86) PCT No.: PCT/GB04/04983

§ 371 Date: Jan. 10, 2007

(30) Foreign Application Priority Data
Nov. 27, 2003 (GB) 0327625.0

(51) Int. Cl. A23L 1/00

(52) U.S. Cl. 99/275

(57) ABSTRACT

A receptacle, particularly a disposable brewing and drinking receptacle, comprises an outer cup, an inner cup nested within the outer cup an ingredient chamber located between mutually opposed bottom walls of the nested cups, and ports formed in the inner cup to permit flow of liquid between the ingredient chamber and the inner cup. The nested cups are coupled together by a screw thread structure which constrains the cups to move relatively to one another with a screw motion, in response to relative twisting of the cups, so that the cups are axially movable together and the bottom walls of the cups exert a squeezing action on an ingredient in the ingredient chamber in order to assist in mixing or infusing the ingredient with the liquid contained in the receptacle.

The present invention relates to a receptacle for containing an ingredient for the preparation of a beverage or other liquid product and in which the ingredient can be mixed or infused with a liquid, such as water, to create the product. More particularly, the invention relates to a disposable brewing and drinking receptacle which is intended to be prefilled with a beverage ingredient, such as tea or coffee, and in which the selected beverage can be brewed, when required, in a controlled fashion, upon the addition of hot or cold water to the receptacle.

It is well known to supply disposable drinking cups containing a powdered or granulated beverage ingredient or teabag in readiness for preparation of a beverage. Such disposable drinking cups are designed to be stacked in nested relation with one another, the ingredient being trapped in an ingredient chamber formed between one cup and the bottom of the next cup above in the stack. When the beverage is to be prepared, the cup is dispensed from the bottom of the stack and water is added to the ingredient contained in the bottom of the cup.

With such so-called “in cup” drinks, there is no effective control of the mixing or infusion of the water with the beverage ingredient contained in the cup, the water simply being added to the ingredient and left to mix or infuse with the ingredient, possibly, assisted by stirring of the resulting beverage. Moreover, it is desirable, for example, in the case of tea or coffee, to remove the teabag, tea leaves or coffee grounds from the cup before drinking the beverage, not only for the purposes of improving the quality of the drink, but also to avoid continued brewing of the beverage after it has attained the desired strength. Depending on circumstances, disposal of the waste ingredient may be messy and inconvenient and, possibly, environmentally unfriendly.

U.S. Pat. No. 6,038,963 describes a disposable beverage brewing system for the single cup brewing of a beverage and which comprises inner and outer cups designed so that the inner cup can snugly fit within the outer cup. The inner cup has a bottom wall formed by a filter screen. In one method of using the system, the ingredient to be brewed and water are disposed in the outer cup and the mixture is allowed to brew for as long as the consumer considers desirable. When the brew is deemed to be acceptable, the inner cup, which serves as a filter press, is pushed into the outer cup and the brewed beverage flows from the outer cup into the inner cup, yia the filter, so that any remaining ingredient is trapped between the outer cup and the filter of the inner cup. The beverage can then be consumed without the need to remove the inner cup. In an alternative method of use, the inner cup is prepositioned in the outer cup, ingredient and water are added to the inner cup and stirred. After brewing for the required time, the inner cup is slowly lifted from the outer cup together with any remaining ingredient and is discarded. The brewed beverage remains in the outer cup.

A controllable brewing device in the form of a disposable plastics drinking receptacle has been proposed in International publication WO-A-2004/008925. It comprises an outer cup having an inner cup dimensioned so as to fit or nest within the outer cup and so that it can turn relatively to the outer cup. In one embodiment, a discrete chamber containing tea or coffee is disposed between the bottoms of the two nested cups and the inner cup has perforations in its bottom wall which may be selectively moved into and out of alignment with perforations in the discrete chamber by rotating the inner cup, whereby to control flow of hot water contained in the inner cup into and from the ingredient in the discrete chamber in order to produce a beverage in the inner cup. In other embodiments, specially shaped cavities are provided in wall portions of the outer cup upstanding from the bottom thereof, for cooperating with perforated upstanding wall portions of the inner cup. Ingredients are positioned in the cavities and liquid poured into the inner cup is mixed or infused with the ingredients in the cavities to produce a beverage by rotation of the inner cup relatively to the outer cup so as selectively to admit and shut off flow of liquid between the inner cup and the ingredient cavities. Natural convection and migration of contents also adds to this process.

The above proposal enables the consumer to determine when the brewing process should start and when it should stop and permits brewing of the beverage to the strength desired by the consumer. Also, it avoids the need to remove loose tea leaves, coffee grounds, other solid ingredients or ingredient containing sachets or bags from the cup, after brewing, and the need to dispose of the ingredients separately. However, the proposal requires the use of either a discrete ingredient chamber or a special arrangement of the ingredient cavities which can create problems in loading the ingredients and assembling the brewing device.

Moreover, in order to produce an acceptable brew, generally, it is necessary to squeeze and/or agitate the ingredient and liquid to produce thorough mixing or infusion. For example, upon the addition of hot water to a teabag, air is initially trapped in the teabag and, subsequently, the teabag absorbs a quantity of the water and swells. It is desirable to express air and, thereafter, water and circulate the latter through the bag in order to provide for the required amount of infusion and brewing. No effective provisions are made in the brewing device disclosed in either the US specification or the International publication for achieving squeezing and/or agitation of the ingredients and added liquid.

An object of the present invention is to provide a receptacle which can be prefilled with an ingredient for the preparation of a beverage or other liquid product and which enables improved and controlled mixing or infusion of the ingredient with liquid added to the receptacle in order to prepare the liquid product. Another, more specific object is to provide a combined brewing and drinking receptacle for a beverage which facilitates initial loading of the beverage ingredient into the receptacle, controlled mixing or infusion of the ingredient with water added to the receptacle in order to prepare the beverage, and disposal of any remaining ingredient after brewing and drinking.

To this end, the present invention consists in a receptacle comprising an outer cup, an inner cup nested within the outer cup, an ingredient chamber located between the nested cups and preferably between opposed bottom walls thereof, and one or more ports formed in the inner cup to permit flow of liquid between the ingredient chamber and the inner cup, the nested cups being coupled together by interengaging means which constrains the cups to move relatively to one another with a screw motion, whereby, in response to relative twisting of the cups, the cups are axially movable relatively to one another so as to exert a squeezing action on an ingredient in the ingredient chamber and assist in mixing or infusing the ingredient with liquid contained in the receptacle.

Conveniently, the inner and outer cups are injection-moulded from plastics material.

In a preferred embodiment of the invention, each cup comprises a bottom wall and an upstanding sidewall inclined generally outwardly from the bottom wall towards the mouth of the cup. The inner and outer cups are designed so that the inner cup, when in a fully closed or nested position within the outer cup, is a tight fit within the latter whilst still defining an ingredient chamber between the bottom walls of the cups, although of a smaller depth. Ports for permitting flow of liquid between the ingredient chamber and the inner cup may be formed in the bottom wall of the inner cup. These may be in the form of a plurality of perforations or small holes in the bottom wall. Ports may also be formed in the sidewall of the inner cup and may, for example, comprise slots extending upwardly of the sidewall from its bottom wall. Additionally, ports in the form of small holes may be formed in the sidewall of the inner cup.

Conveniently, the interengaging means coupling the cups together is formed in the sidewalls of the cups at and adjacent to the mouths of the cups. It may comprise one or more protuberances on the sidewall of one of the cups slidably engaged in one or more grooves formed in the sidewall of the other cup. The or each groove is inclined to the axis of the receptacle so as to produce the desired screw motion when the cups are relatively twisted. In the preferred embodiment, protuberances are formed on the outside of the sidewall of the inner cup and the cooperating grooves are formed on the inside of the sidewall of the outer cup. The upper end of the or each groove may terminate in a ledge or other abutment so that the cooperating protuberance is a snap-fit into the upper end of the groove and the inner cup is thereby retained in nested relation with the outer cup. This also defines the maximum height and size of the ingredient chamber between the bottom walls of the cups and is designed to allow maximum brewing of an ingredient in the ingredient chamber, for example, a standard size tea bag. The upper and lower ends of the or each groove may also be formed with means for engaging the cooperating protuberance so as to retain the inner cup in its fully open and fully closed position.

The inner cup may have a rim flange depending from the rim about the mouth of the inner cup and outside the sidewall of the outer cup. This rim flange serves to conceal the rim of the outer cup and enable a consumer comfortably to drink from the receptacle.

The receptacle according to the invention may be supplied with an ingredient contained in the ingredient chamber. The ingredient may be disposed in the ingredient chamber either in loose form or in a liquid permeable sachet or bag, such as a tea bag. Locating the ingredient chamber between the bottom walls of the inner and outer cups has the advantage of providing a brewing receptacle which is easy to load with an ingredient in either loose form or in a bag. It is simply loaded into the bottom of the outer cup, whereafter the inner cup can be readily assembled to the outer cup with the ingredient in place.

The invention enables the ingredient to be mixed or infused in a controlled fashion with water or other liquid added to the inner cup. When added, the liquid flows through the ports in the inner cup and into the ingredient chamber. Relative turning or twisting of the cups squeezes and agitates the contents of the ingredient chamber between the bottom walls of the cups so as to enhance mixing or infusion of the liquid with the ingredient. This can be done as many times as desired. When, for example, a tea drink being brewed has reached a desired strength in response to relative twisting of the cups, the cups are screwed together so as to move the inner cup to its fully closed position within the outer cup, whereupon ports in the bottom wall of the inner cup are effectively shut off by engagement with the compressed tea bag in the ingredient chamber to prevent further brewing. Ports in the sidewall of the inner cup, if provided, are shut off by its tight engagement with the sidewall of the outer cup when the inner cup is in its fully screwed-in or closed position. When the ingredient chamber is shut off, or effectively shut off, the remaining ingredient can no longer affect the strength or quality of the resulting beverage in the inner cup. After the beverage has been consumed, the receptacle may be disposed of together with any ingredient or ingredient bag retained within the receptacle. On the other hand, before disposal, the receptacle may be used, if acceptable, to prepare a second cup of beverage by adding fresh water to the inner cup and repeating the process.

The sidewall of the outer cup may be formed externally with an array of axially extending ribs which facilitate gripping of the container by a consumer. They enable the container to be held more comfortably when the content is a hot beverage and this advantage is further enhanced by the insulating characteristics inherent in the double wall construction of the receptacle. The outer cup may have a plain area below the ribs for printing, embossing or other form of decoration or advertisement. Moreover, the outer cup may be transparent, as may also be the inner cup, to show the infusion and brewing mechanism or to give some combined inner cup/outer cup decorative feature.

In order that the present invention may be more readily understood, reference will now be made to the accompanying drawings, in which:—

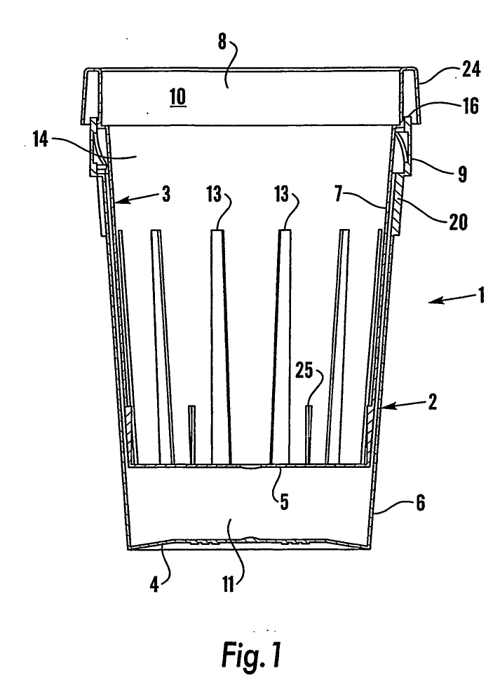

FIG. 1 is an axial section of one embodiment of the present invention, which is a disposable brewing and drinking receptacle or cup, and illustrates the inner cup in its fully open or outermost nested position,

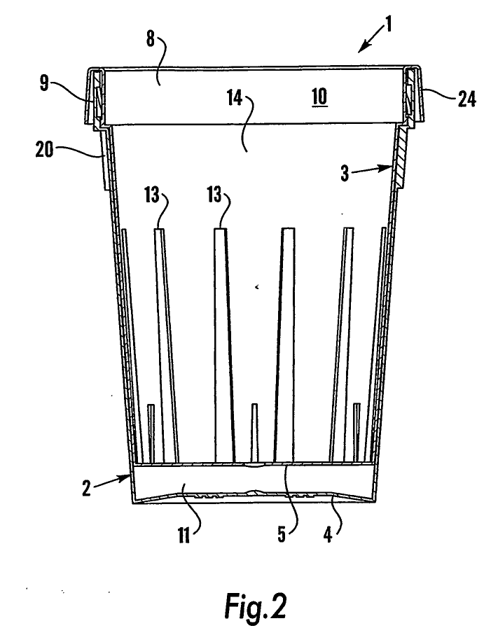

FIG. 2 is a view similar to FIG. 1 illustrating the inner cup in its fully closed or fully nested position,

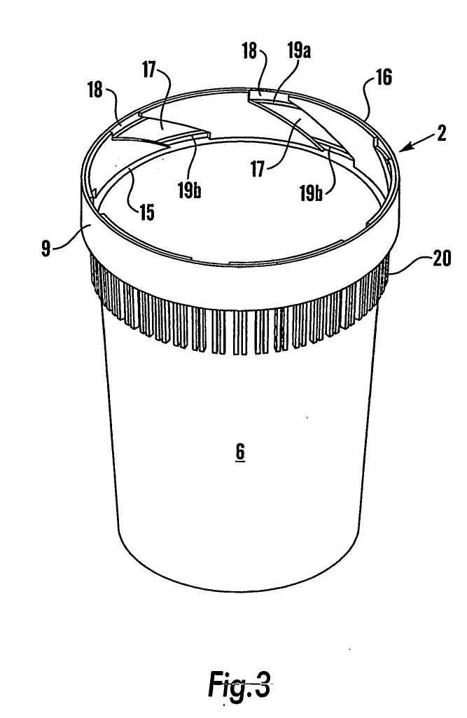

FIG. 3 is a perspective view from above of the outer cup of the receptacle shown in FIG. 1,

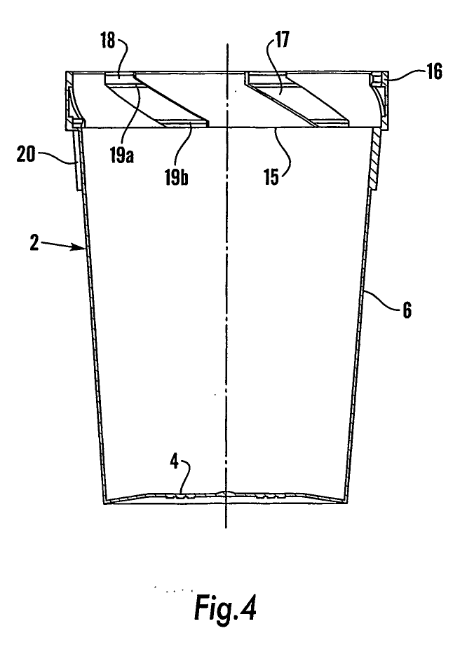

FIG. 4 is an axial section of the outer cup,

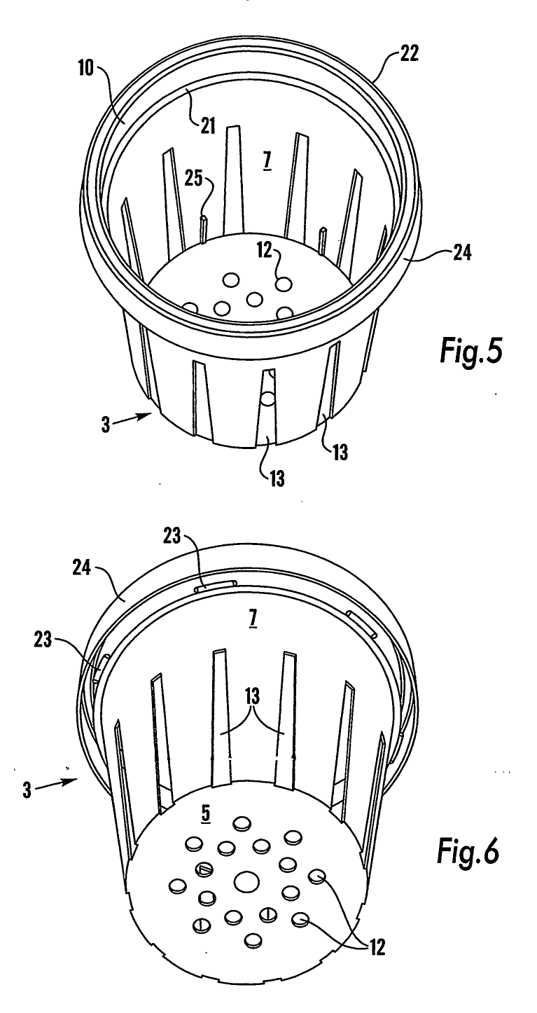

FIG. 5 is a perspective view from above of the inner cup of the receptacle shown in FIG. 1,

FIG. 6 is a perspective view from below of the inner cup, and

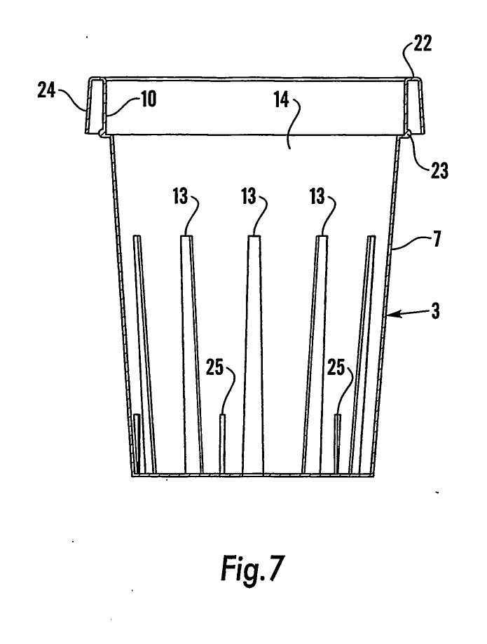

FIG. 7 is an axial section of the inner cup.

Referring to the accompanying drawings, the disposable brewing and drinking receptacle or cup 1 comprises an outer cup component 2 and an inner cup component 3 nested within the outer cup component. These cup components or cups, as they are herein called, are preferably injection moulded from plastics material.

Each of the outer and inner cups 2,3 is of circular shape in plan and has a bottom wall 4,5 and an upstanding sidewall comprising a lower inclined section 6,7 extending upwardly and outwardly at a small angle, for example 4° from vertical, from its bottom wall towards a mouth 8 at the top of the receptacle, and a cylindrical collar 9,10 terminating the inclined section at the mouth 8. The cups are retained in nested relationship so as to be rotatable and axially movable relatively to one another with a screw motion by a screw thread interengaging structure formed on the cylindrical collars 9,10 of the sidewalls. The bottom walls 4,5 of the nested cups are spaced apart and define an ingredient chamber 11 therebetween for containing a beverage ingredient (not shown) capable of mixing with hot or cold water to produce the beverage. For example, the beverage ingredient may be tea in a conventional tea bag, loose tea or coffee grounds. Ports 12 in the form of a plurality of small round holes are disposed in the bottom wall 5 of the inner cup to permit flow of liquid between the ingredient chamber 11 and the interior 14 of the inner cup. For this purpose also, ports 13 are disposed in the sidewall section 7 of the inner cup. These sidewall ports are formed as slots 13 extending upwardly from the bottom wall 5 of the inner cup.

The screw thread structure permits the inner cup 3 to be screwed into the outer cup 2 from the fully open or outermost position illustrated in FIG. 1 to the fully closed or fully nested position illustrated in FIG. 2, and vice versa. The inner and outer cups are configured such that, in the fully nested position, the inclined sidewall section 7 of the inner cup fits tightly against the section 6 of the outer cup.

The cylindrical collar 9 at the mouth of the outer cup 2 is joined at its lower end to the inclined section 6 of the sidewall by an annular shoulder 15 and terminates at its upper end in the rim 16 of the outer cup. On its inside the cylindrical collar is moulded with a plurality of equally spaced grooves 17 inclined to the axis of the cup and extending from adjacent the rim 16 to the shoulder 15. The grooves 17 are of generally rectangular shape in section and terminate just short of the rim 16 so as to leave a narrow lip or ledge 18 between the upper end of each groove and the rim. Each groove also has a small latching recess 19a at its upper end, adjoining the lip 18, and another small latching recess 19b at its lower end, adjoining the shoulder 15.

On both its inside and outside, the inclined section 6 of the sidewall of the outer cup is moulded so as to be smooth sided except for an array of ribs 20 moulded in an annular zone on the outside of the inclined section and adjoining the shoulder 15. These ribs serve as a gripping and insulating zone where the outer cup may be conveniently gripped by the fingers of a consumer.

The cylindrical collar 10 about the mouth of the inner cup is designed snugly to fit within the cylindrical collar 9 of the outer cup when the two cups are internested. The cylindrical collar 10 is joined at its lower end to the inclined sidewall section 7 of the inner cup by an annular shoulder 21 and terminates at its upper end in a rim 22 of the inner cup which, when the inner and outer cups are assembled, forms the rim of the drinking cup 1. Moulded at equally spaced positions about the outside of the cylindrical collar 10 so as to match the spacing of the grooves 17 are a plurality of protuberances 23. These protuberances adjoin the shoulder 21 and are of such an arcuate length as to fit between opposite edges of a groove 17 when the cups are internested. A rim flange 24 depends downwardly from the rim 22 about the outside of the inner cup for substantially the full height of the cylindrical collar 10. It is spaced from the latter by a sufficient distance for receiving the rim 16 of the outer cup when the inner and outer cups are nested together. Except for the ports 13, the inclined sidewall section 7 of the inner cup is moulded so as to be smooth sided.

When initially interengaged in nested relation, the protuberances 23 are positioned opposite the upper ends of the grooves 17 and are snapped into the grooves over the lips 18 defining the upper ends of the grooves, whereupon they engage in the upper latching recesses 19a of the grooves. By this means, the two cups are securely retained in nested relationship and in a fully open position. Thereafter, when the inner cup is twisted relatively to the outer cup, the protuberances 23 disengage from the latching recesses 19a and the screw thread interengaging structure comprised of the protuberances and the grooves 17 constrains the cups to move relatively to one another with a screwing motion. The arrangement is such that the inner cup moves axially from the position illustrated in FIG. 1, where the ingredient chamber 11 is of a maximum size, to the fully closed or fully nested position shown in FIG. 2, where the ingredient chamber is compressed to its minimum size. The arrangement of the screw thread structure is such that the inner cup is twisted approximately 45° relatively to the outer cup in order to move it from its initial position to the fully nested position. The maximum size of the ingredient chamber 11, which is defined by the inner cup being in its outermost or fully open position, is dimensioned so as to be of sufficient size to accommodate the type of beverage component to be used in the drinking cup, for example, in the case of a tea drink, it is dimensioned to allow maximum brewing of a standard size tea bag.

In use, an ingredient, such as a conventional circular tea bag, is loaded into the bottom of the outer cup 2 prior to assembly of the outer and inner cups, as described above. At its maximum size illustrated in FIG. 1, the ingredient chamber 11 is designed to allow for expansion and/or floating of the ingredient, when liquid is added, and so that the positioning of the ingredient in the outer cup, before assembly, does not obstruct subsequent nesting of the inner and outer cups.

When preparing a beverage from an ingredient, for example, a tea bag, trapped in the ingredient chamber 11, hot water is added to the inner cup and flows through the ports 12,13 into the ingredient chamber. The tea bag in the chamber begins to expand on contact with the hot water and floats up towards the bottom wall of the inner cup. Thereafter, the inner cup is twisted relative to the outer cup in a direction to cause the cups to screw together, which compresses the ingredient chamber 11 and squeezes the tea bag between the bottom walls 4,5 of the cups. This forces the brewed/brewing tea through the ports 12,13 into the interior 14 of the inner cup 3. The inner cup may be twisted backwards and forwards relatively to the outer cup in order alternatively to squeeze and release and agitate the tea bag between the bottom walls of the cups and thereby enhance infusion of the hot water with the tea bag and the brewing process. When a brew of desired strength has been produced, the inner cup is twisted in order fully to screw the inner cup into the outer cup, whereupon the protuberances 23 snap into engagement with the latching recesses 19b in order to retain the inner cup in this fully closed or nested position. In the fully closed position, the inclined sidewall sections 6,7 of the inner and outer cups fit tightly together so that the sidewall ports 13 are shut off and the bottom wall 5 of the inner cup is pressed against the tea bag in the ingredient chamber which effectively shuts off the ports 12 in the bottom wall. Thereafter, milk and sugar may be added to the tea in the inner cup, if required, in order to complete the tea drink.

The construction of the brewing and drinking cup enables the infusion of a tea bag with hot water to be effectively controlled without the need to remove the tea bag from the container or to add further ingredients or water to the inner cup after initial infusion. If adequate ingredient is loaded into the ingredient chamber when the drinking cup is initially assembled, there may be sufficient ingredient to allow for the preparation of more than one acceptable drink. Hence, after a first drink has been consumed, the inner cup 3 may be twisted to open the ports 12,13 and hot water may again be added to the inner cup to enable another charge of water to infuse with the tea bag in the ingredient chamber 11 and thereby produce a second drink. Again, the inner cup is twisted relative to the outer cup to shut off the ports, as described above, when the second drink has acquired the desired strength.

The drinking cup is conveniently gripped by a consumer at the ribbed zone 20 and the ribs serve to insulate the consumers fingers from a hot drink in the drinking cup. The insulation is enhanced by the double-walled structure provided by the assembled inner and outer cup components 2,3. Moreover, the insulation may be supplemented by the use of a wrap around label or sleeve of suitable material disposed about the sidewall 6 of the outer cup. An anti-splash lid may be fitted to the mouth of the drinking cup by simply snapping the lid into engagement with the lower end of the rim flange 24 of the inner cup, or by frictionally engaging the lid with the inside of the collar 10 of the inner cup. Finally, when the disposable drinking cup has been used, the tea bag or any other remaining ingredients in the ingredient chamber 11 are automatically disposed of with the drinking cup.

A multiplicity of the drinking cups 1 may be stacked in nested relation for storage and transportation purpose. When stacked in nested relation, the stacked cups are prevented from wedging or jamming together in the stack by the bottom of the upper drinking cup 1 resting, via the bottom wall 4 of its outer cup component, on the upper shoulders of the stacking ribs 25 of the inner cup component 3 of the next drinking cup below. These are also used to stack the inner cups during storage and transportation prior to filling and assembly of the drinking cups 1. The ribs 20 and the shoulders 21 of the outer cups are used for this purpose to stack the outer cups in nested relation prior to assembly.

Whilst a particular embodiment has been described, it will be understood that modifications can be made without departing from the scope of the invention as defined by the appended claims. For example, whilst the invention has been particularly described as a drinking cup suitable for brewing a desired beverage, it will be apparent that the receptacle of the invention is also suitable for use in other circumstances, such as, for mixing alcoholic drinks, medicines and paints.

1. A receptacle comprising an outer cup, an inner cup nested within the outer cup, an ingredient chamber located between the nested outer and inner cups, and one or more ports formed in the inner cup to permit flow of liquid between the inner cup and the ingredient chamber, wherein the nested cups are coupled together by first and second interengaging mechanisms which constrains the cups to move relative to one another with a screw motion, whereby, in response to relative twisting of the cups, the cups are axially movable relatively to one another so as to exert a squeezing action on an ingredient in the ingredient chamber to assist in mixing or infusing the ingredient with a liquid contained in the receptacle.

2. A receptacle as claimed in claim 1, wherein the ingredient chamber is defined by a bottom wall of the outer cup and by a mutually opposed bottom wall of the inner cup.

3. A receptacle as claimed in claim 1, wherein the outer cup includes a sidewall inclined generally outwardly towards a mouth of the receptacle, and wherein the inner cup includes a sidewall inclined generally outwardly towards the mouth at the receptacle.

4. A receptacle as claimed in claim 2, wherein the inner and outer cups are designed so that when the cups are relatively twisted to move the inner cup to a fully closed or nested position within the outer cup, the inner cup is a tight fit within the outer cup and defines an ingredient chamber of reduced depth between the mutually opposed bottom walls of the cups.

5. A receptacle as claimed in claim 2, wherein at least one port for permitting flow of liquid between the ingredient chamber and the inner cup is formed in the bottom wall of the inner cup.

6. A receptacle as claimed in claim 5, wherein said at least one port comprises a plurality of perforations or small holes in the bottom wall of the inner cup.

7. A receptacle as claimed in claim 1, wherein at least one port for permitting flow of liquid between the ingredient chamber and the inner cup is formed in a sidewall of the inner cup.

8. A receptacle as claimed in claim 7, wherein the at least one port in the sidewall of the inner cup comprises a slot extending upwardly of the sidewall of the inner cup from a bottom wall of the inner cup and/or holes formed in the sidewall of the inner cup.

9. A receptacle as claimed in claim 1, wherein the first interengaging mechanism is formed on a first substantially cylindrical collar associated with a sidewall of the inner cup and the second interengaging mechanism is formed on a second substantially cylindrical collar associated with a sidewall of the outer cup.

10. A receptacle as claimed in claim 9, wherein one of the first or second interengaging mechanisms comprises one or more protuberances on the collar of one of the cups and the other of the first or second interengaging means comprises one or more grooves formed in the collar of the other cup, wherein each groove is inclined to the axis of the receptacle so as to produce the desired screw motion when the cups are relatively twisted.

11. A receptacle as claimed in claim 10, wherein the protuberances are formed on the outside of the collar of the inner cup and the cooperating grooves are formed on the inside of the collar of the outer cup.

12. A receptacle as claimed in claim 10, wherein the upper end of each groove terminates in abutment means so that the cooperating protuberance is a snap-fit into the upper end of the groove, to retain the inner cup in nested relation with the outer cup and define the maximum height of the ingredient chamber.

13. A receptacle as claimed in claim 10, wherein the upper and lower ends of each groove are formed with means for engaging the cooperating protuberances so as to index the inner cup in its fully open and fully nested position.

14. A receptacle as claimed in claim 1, wherein the first and second interengaging mechanisms are adapted to permit the inner and outer cups to twist relatively to one another through approximately 45° in order to screw the inner cup from its fully open to its fully nested position.

15. A receptacle as claimed in claim 9, wherein the substantially cylindrical collars of the respective first and second interengaging mechanisms are disposed at the upper ends of the sidewalls of the outer and inner cups.

16. A receptacle as claimed in claim 1, wherein the inner cup has a rim flange depending from the rim of the cup about the outside of the outer cup that is configured to conceal the rim of the outer cup.

17. A receptacle as claimed in claim 1, wherein the sidewall of the outer cup is formed externally with an array of axially extending ribs.

18. A receptacle as claimed in claim 17, wherein the outer cup has a plane area below the ribs for enabling printing, embossing or other form of decoration or advertisement.

19. A receptacle as claimed in claim 1, wherein the outer cup is transparent or translucent.

20. A receptacle as claimed in claim 1, wherein the outer and inner cups are injection moulded from plastics material.

21. A receptacle as claimed in claim 1, including stacking shoulders formed on the inside of the sidewall of the inner cup which are engageable with the bottom wall of an outer cup when a multiplicity of receptacles are stacked in nested relation to prevent the receptacles jamming or wedging together when restacked.

22. A receptacle as claimed in claim 1, further including an ingredient disposed in the ingredient chamber.

23. A method of preparing a liquid product in a receptacle comprising an inner cup nested within an outer cup and defining an ingredient chamber between mutually opposed bottom walls of the nested cups, an ingredient disposed in the ingredient chamber, and one or more ports formed in the inner cup to permit flow of liquid between the ingredient chamber and the inner cup, the method comprising:
adding to the inner cup liquid for producing the liquid product;
twisting the cups relatively to one another; and
constraining the cups to move relative to one another with a screw motion in response to twisting such that the cups also move axially relatively to one another and the bottom walls of the cups exert a squeezing action on the ingredient in the ingredient chamber to assist in mixing or infusing the ingredient with the liquid contained in the receptacle.

24. A method as claimed in claim 23, wherein at least a first of the one more ports for permitting flow of liquid between the ingredient chamber and the inner cup is disposed in the bottom wall of the inner cup and, when desired infusion or mixing has been achieved, the cups are screwed together so as to move the inner cup to its fully nested position within the outer cup to shut off the at least a first of the one or more ports by engagement with compressed ingredient in the ingredient chamber.

25. A method as claimed in claim 23, wherein at least a first of the one or more ports is disposed in the sidewall of the inner cup and is shut off by tight engagement with the sidewall of the outer cup when the cups are screwed together so as to move the inner cup to its fully nested position within the outer cup.
